(19) United States
(12) Patent Application Publication
(10) Pub. No.: US 2023/0206346 A1
(43) Pub. Date: Jun. 29, 2023

(54) INFORMATION PROCESSING APPARATUS AND ACCOUNTING SYSTEM

(71) Applicant: TOSHIBA TEC KABUSHIKI KAISHA, Tokyo (JP)

(72) Inventor: Tomotaka Murakami, Yaizu Shizuoka (JP)

(21) Appl. No.: 17/852,436

(22) Filed: Jun. 29, 2022

(30) Foreign Application Priority Data
Dec. 24, 2021 (JP) 2021-210692

(51) Int. Cl. G06Q 40/00

(52) U.S. Cl. CPC G06Q 40/12

(57) ABSTRACT

An information processing apparatus and an accounting system capable of improving a service for a customer are provided. An information processing apparatus according to an embodiment is an information processing apparatus to be used in an accounting system. The accounting system includes: a registration device configured to register, by an operation of a salesclerk, commodity information of a commodity purchased by a customer; and a plurality of accounting devices configured to execute accounting processing by an operation of the customer based on the commodity information registered by the registration device. The information processing apparatus includes: a management unit configured to manage a use status of the plurality of accounting devices; an acquisition unit configured to acquire request information indicating a request of the customer related to selection of the accounting devices; and a selection unit configured to select the accounting device as an output destination of the commodity information output by the registration device, based on the use status managed by the management unit and the request information acquired by the acquisition unit.

### CROSS-REFERENCE TO RELATED APPLICATION

This application is based upon and claims the benefit of priority from Japanese Patent Application No. 2021-210692, filed on Dec. 24, 2021, the entire contents of which are incorporated herein by reference.

### FIELD

Embodiments described herein relate generally to an information processing apparatus and an accounting system.

### BACKGROUND

In recent years, a POS system called a semi-self point of sales (POS), a POS system called a cart POS, and the like is put into practical use in stores that sell commodities and services (hereinafter, collectively referred to as a “commodity”).

The semi-self POS includes a plurality of registration devices that are operated by salesclerks to execute registration of commodity information (hereinafter, also referred to as “commodity registration”) and a plurality of accounting devices that are operated by customers to execute accounting processing of a purchase price. In addition, the cart POS includes a plurality of registration devices that are implemented by a tablet terminal, a smartphone, or the like supported by a shopping cart and are operated by customers to execute commodity registration, and a plurality of accounting devices that are operated by the customers to execute accounting processing of a purchase price.

With the semi-self POS, a salesclerk transmits accounting information including the registered commodity information to any of the accounting devices, and notifies a customer of the number or the like of the accounting device. The customer pays the purchase price by the accounting device of the notified number.

However, some customers may request a specific accounting device. For example, it is conceivable that a customer requests an accounting device as close as possible to an exit to be used by the customer in order to shorten a distance for carrying the purchased commodity taken out from the shopping cart. In addition, since a hearing-impaired customer does not know the number of an accounting device notified of by the salesclerk, it is conceivable that the customer always requests the same accounting device.

However, with a semi-self POS in the related art, since an accounting device for payment by a customer is selected without considering a request of the customer, a service for the customer is not always sufficient.

With the cart POS, a customer pays a purchase price by any accounting device after completing commodity registration of commodities to be purchased. With the cart POS, the customer himself/herself can select an accounting device. However, when the commodity registration is completed, the customer is often at a position away from an accounting space in which the accounting device is provided, and does not know whether the accounting device requested by the customer is available. In this regard, the service for the customer is not always sufficient.

DESCRIPTION OF THE DRAWINGS

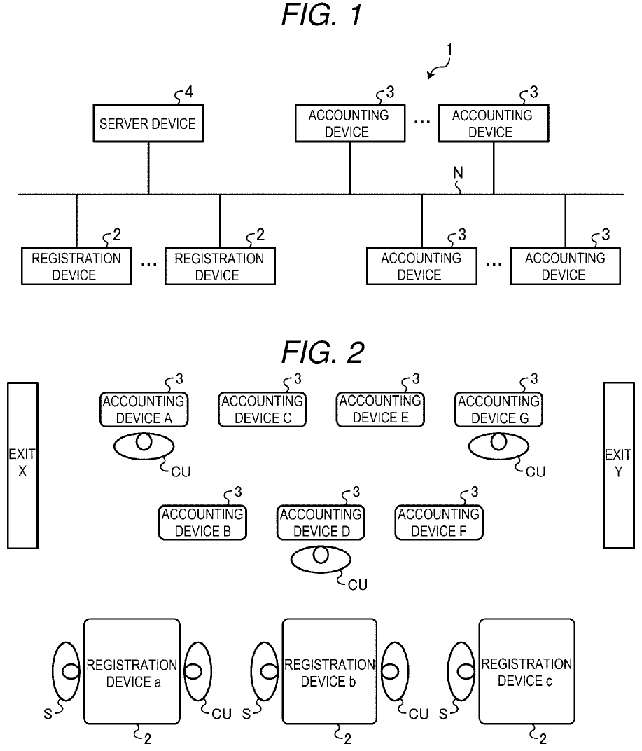

FIG. 1 is a diagram illustrating a configuration of an accounting system according to a first embodiment;

FIG. 2 is a diagram illustrating an accounting space of a store to which the accounting system is applied;

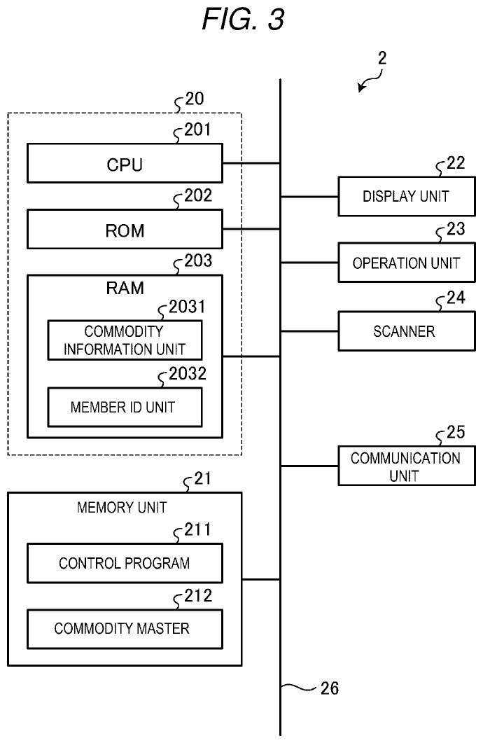

FIG. 3 is a block diagram illustrating a main hardware configuration of a registration device;

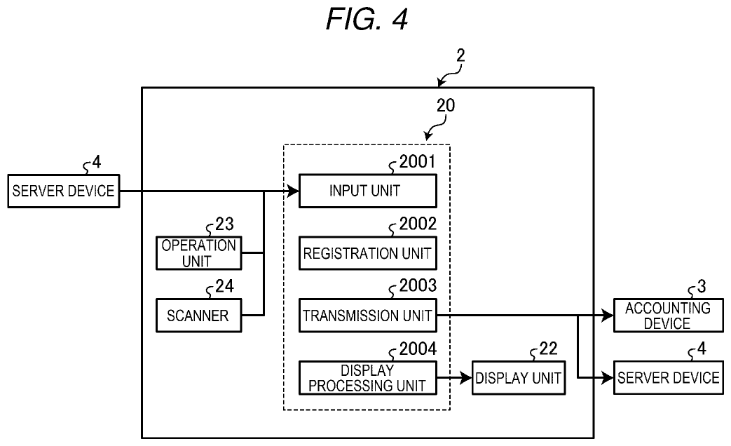

FIG. 4 is a block diagram illustrating a main functional configuration of a control unit;

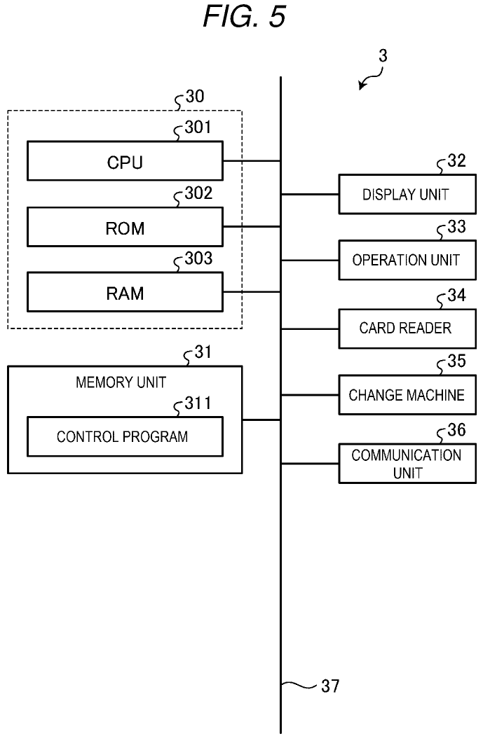

FIG. 5 is a block diagram illustrating a main hardware configuration of an accounting device;

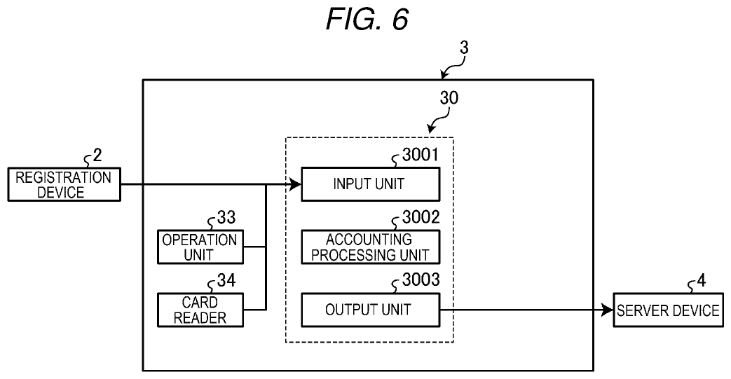

FIG. 6 is a block diagram illustrating a main functional configuration of a control unit;

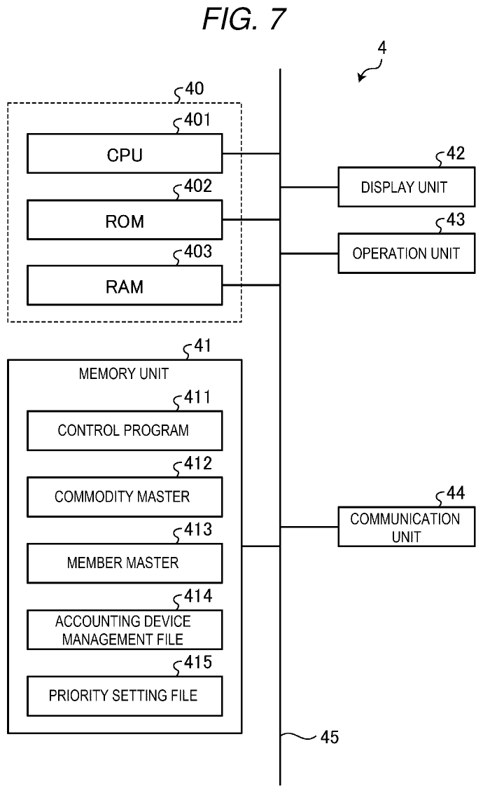

FIG. 7 is a block diagram illustrating a main hardware configuration of a server device;

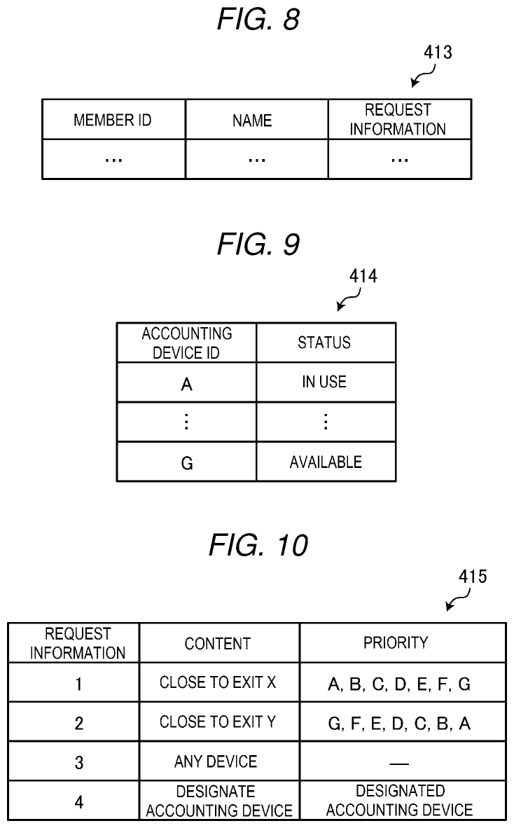

FIG. 8 is a diagram illustrating a data configuration of a member master stored in a memory unit;

FIG. 9 is a diagram illustrating a data configuration of an accounting device management file stored in the memory unit;

FIG. 10 is a diagram illustrating a data configuration of a request information setting file stored in the memory unit;

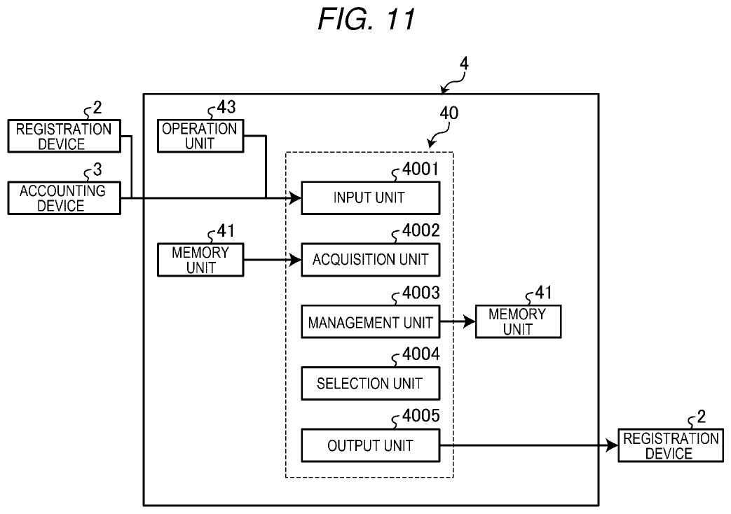

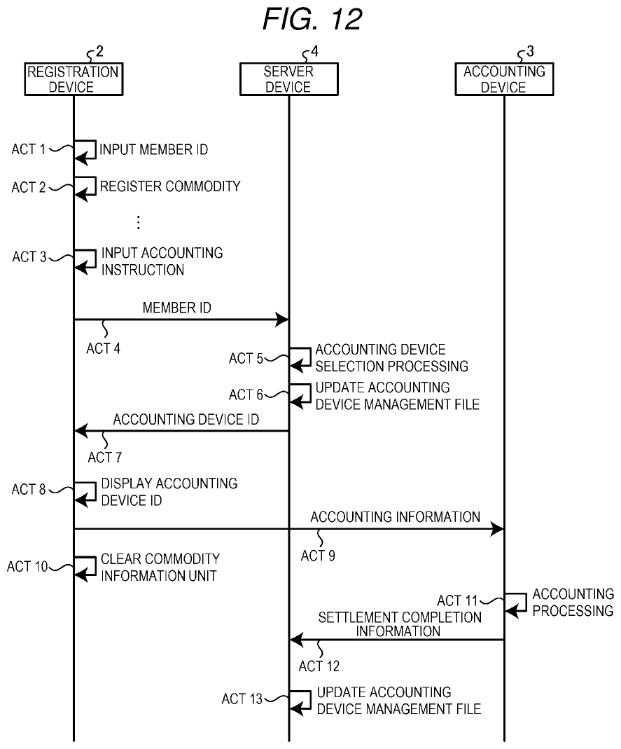

FIG. 11 is a block diagram illustrating a main functional configuration of a control unit;

FIG. 12 is a sequence chart of a flow of operations of the accounting system;

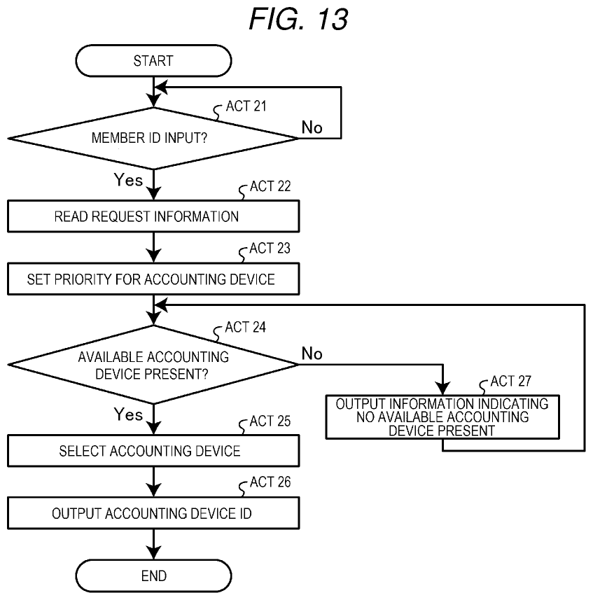

FIG. 13 is a flowchart illustrating a flow of accounting device selection processing performed by the control unit;

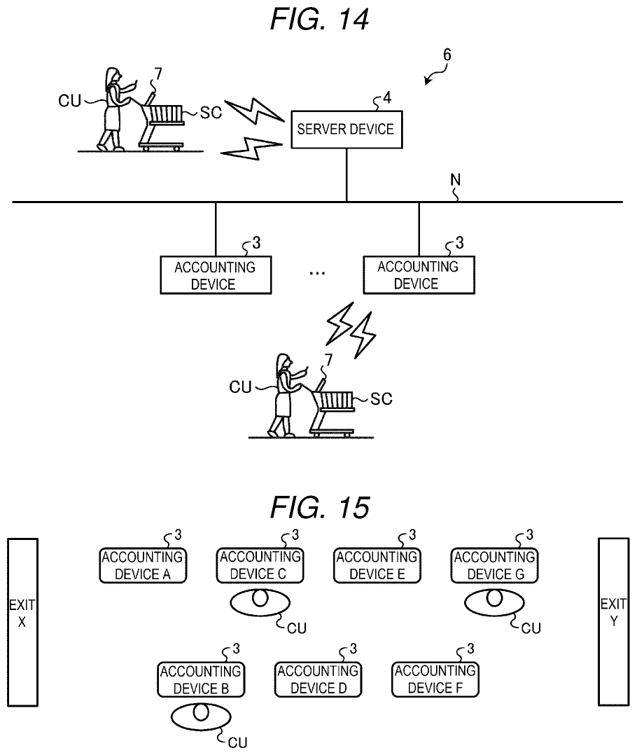

FIG. 14 is a diagram illustrating a configuration of an accounting system according to a second embodiment;

FIG. 15 is a diagram illustrating an accounting space of a store to which the accounting system is applied;

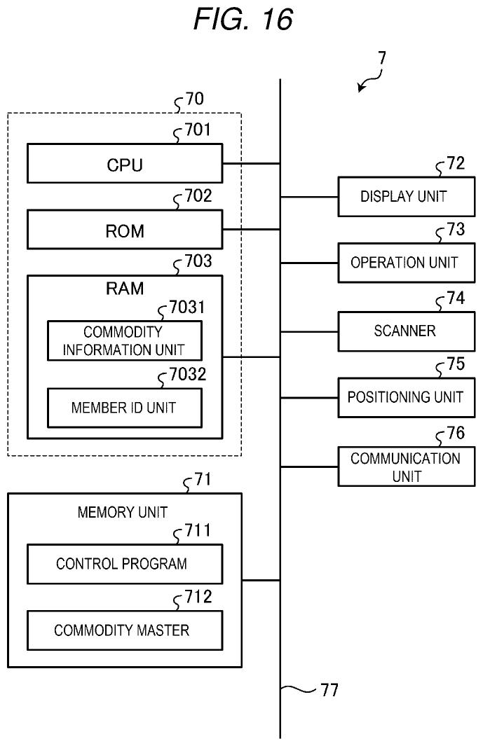

FIG. 16 is a block diagram illustrating a main hardware configuration of a registration device;

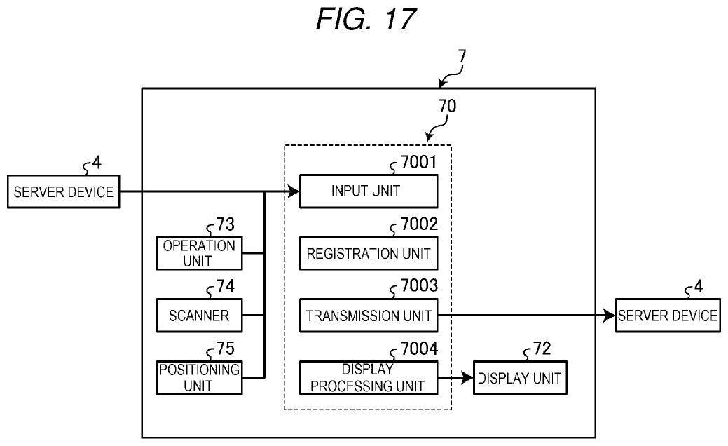

FIG. 17 is a block diagram illustrating a main functional configuration of a control unit;

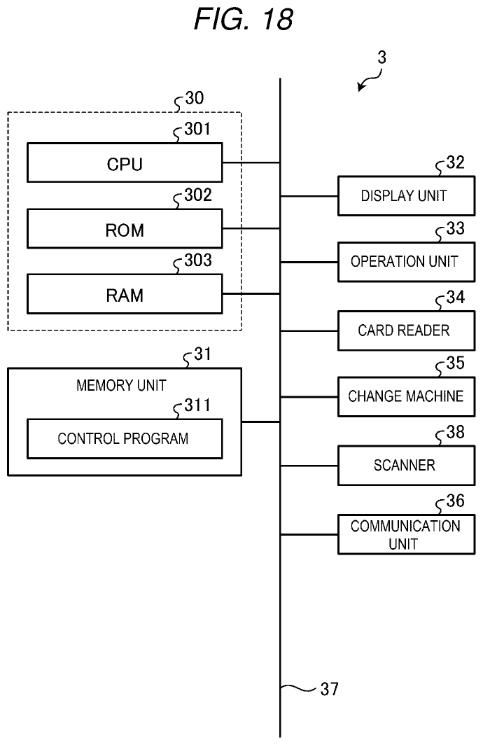

FIG. 18 is a block diagram illustrating a main hardware configuration of an accounting device;

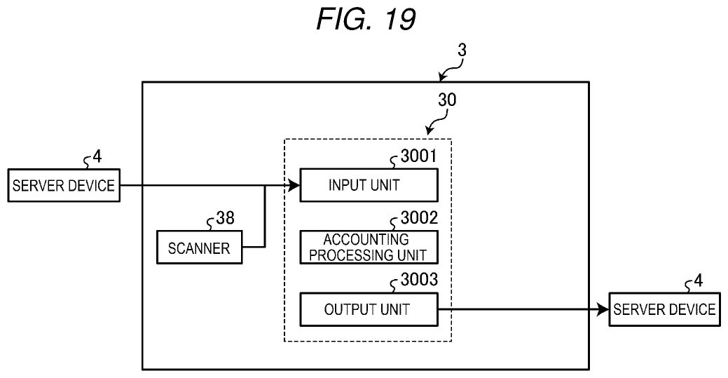

FIG. 19 is a block diagram illustrating a main functional configuration of a control unit;

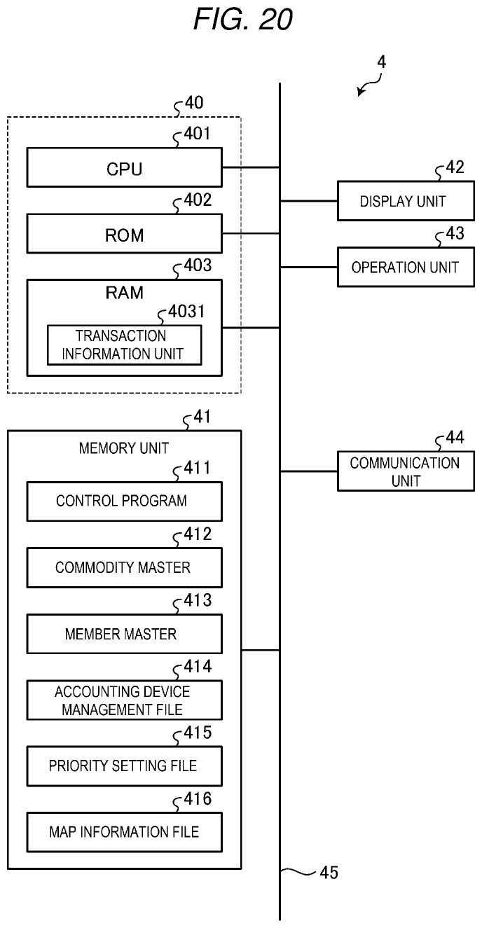

FIG. 20 is a block diagram illustrating a main hardware configuration of a server device;

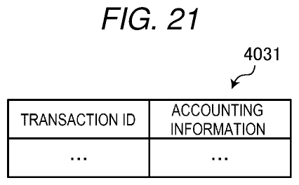

FIG. 21 is a diagram illustrating a data configuration of a transaction information unit stored in an RAM;

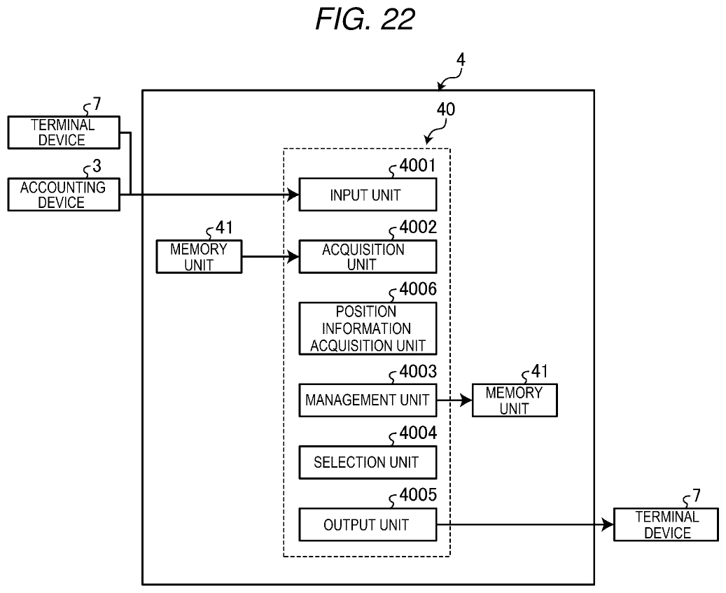

FIG. 22 is a block diagram illustrating a main functional configuration of a control unit;

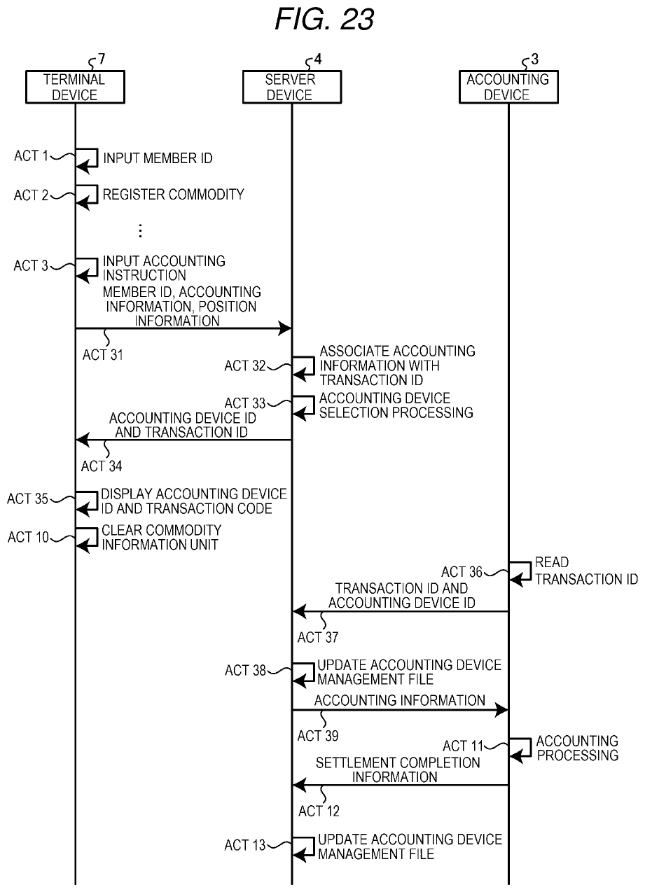

FIG. 23 is a sequence chart illustrating a flow of operations of the accounting device;

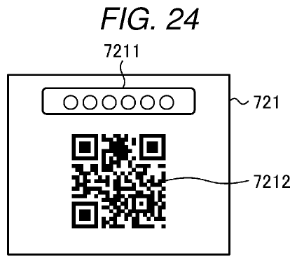

FIG. 24 is a diagram illustrating a display screen of a terminal device; and

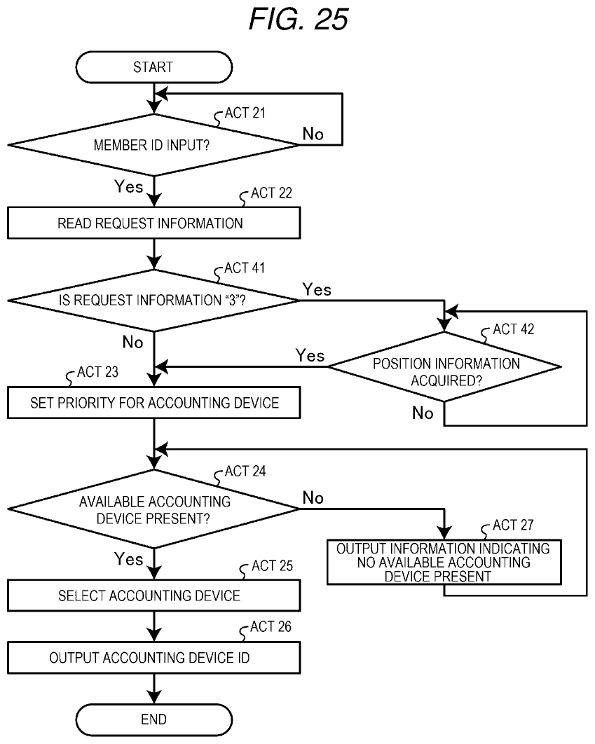

FIG. 25 is a flowchart illustrating a flow of accounting device selection processing by the control unit.

### DETAILED DESCRIPTION

In general, according to one embodiment, an information processing apparatus and an accounting system capable of improving a service for a customer are provided.

An information processing apparatus according to an embodiment is an information processing apparatus to be used in an accounting system. The accounting system includes: a registration device configured to register, by an operation of a salesclerk, commodity information of a commodity purchased by a customer; and a plurality of accounting devices configured to execute accounting processing by an operation of the customer based on the commodity information registered by the registration device. The information processing apparatus includes: a management unit configured to manage a use status of the plurality of accounting devices; an acquisition unit configured to acquire request information indicating a request of the customer related to selection of the accounting devices; and a selection unit configured to select the accounting device as an output destination of the commodity information output by the registration device, based on the use status managed by the management unit and the request information acquired by the acquisition unit.

Hereinafter, an information processing apparatus and an accounting system according to an embodiment will be described with reference to the drawings. An exemplary embodiment is not limited to each embodiment described below. For example, in each embodiment, an example in which an information processing apparatus serves as a server device will be described, and the information processing apparatus may also serve as a registration device. In addition, a function of the information processing apparatus may be realized by cooperation between a server device and a registration device.

### First Embodiment

Hereinafter, an information processing apparatus and an accounting system according to a first embodiment will be described with reference to the drawings. In the first embodiment, the accounting system is a semi-self POS system. FIG. 1 illustrates a configuration of an accounting system 1. The accounting system 1 includes a plurality of registration devices 2, a plurality of accounting devices 3, and a server device 4. The registration devices 2, the accounting devices 3, and the server device 4 are communicably connected to one another via a network N. The network N is, for example, a wired or wireless local area network (LAN). Although the number of the registration devices 2 and the number of the accounting devices 3 can be any number, it is desirable that the number of the accounting devices 3 is larger than the number of the registration devices 2.

Each registration device 2 is operated by a salesclerk S (see FIG. 2). The registration device 2 executes commodity registration of a commodity purchased by a customer CU (see FIG. 2), and outputs (transmits) commodity information of the registered commodity for one transaction to any of the accounting devices 3 as accounting information. Details of the registration device 2 will be described later.

Each accounting device 3 is operated by a customer CU. The accounting device 3 executes accounting processing based on the accounting information received from the registration device 2. The accounting processing is executed for the customer CU to pay a purchase price of the commodity. For example, the accounting processing includes processing of displaying a transaction amount (a total amount of purchase prices related to one transaction), processing related to change, processing related to credit settlement, processing related to receipt printing, and the like. Details of the accounting device 3 will be described later.

The server device 4 functions as a store server that manages various types of information of a store. For example, the server device 4 executes sales management and the like of the store based on information from each accounting device 3. The server device 4 manages status information indicating a use status of each accounting device 3, and based on the status information and a request of the customer CU, selects an accounting device 3 for the customer CU to make a payment. The server device 4 is an example of the information processing apparatus. Details of the server device 4 will be described later.

FIG. 2 is a diagram illustrating an accounting space of the store to which the accounting system 1 according to the present embodiment is applied. An exit X and an exit Y are provided at both sides of the accounting space. In the accounting space, three registration devices 2 (registration device a to registration device c) are installed at a salesroom (not illustrated) side. In the accounting space, seven accounting devices 3 (accounting device A to accounting device G) are installed at positions farther from the salesroom than each registration device 2. In the following description, the registration device a to the registration device c are referred to as the registration devices 2 when the registration device a to the registration device c are not particularly distinguished from one another. Similarly, the accounting device A to the accounting device G are referred to as the accounting devices 3 when the accounting device A to the accounting device G are not particularly distinguished from one another.

When the customer CU brings purchased commodities to the registration device 2, the salesclerk S performs commodity registration for the purchased commodities. At this time, a member ID that specifies the customer CU is input to the registration device 2 by an operation of the salesclerk S or the customer CU. When commodity registration of all the purchased commodities is completed, the salesclerk S performs accounting instruction input, which declares completion of one transaction, in other words, an accounting instruction, to the registration device 2.

When the accounting instruction input is performed to the registration device 2, the registration device 2 transmits the member ID that specifies the customer CU to the server device 4. The server device 4 extracts request information indicating a request of the customer CU related to selection of the accounting devices 3 from a member master. Then, the server device 4 selects an accounting device 3 for the customer CU to make a payment, based on the status information of each accounting device 3 and the extracted request information.

For example, in a situation illustrated in FIG. 2, when the request information indicates that the customer requests an accounting device close to the exit Y, the server device 4 selects the accounting device F that is closest to the exit Y, which is an accounting device 3 not being used by another customer CU. Then, the server device 4 outputs an accounting device ID that specifies the selected accounting device 3 to the registration device 2. The accounting device ID is an example of specific information that identifies any of the accounting devices 3.

When the accounting device ID is input from the server device 4, the registration device 2 transmits accounting information to the accounting device 3, which is specified by the accounting device ID, automatically or by an operation of the salesclerk S. At this time, the registration device 2 displays, on the display unit, the specific information such as the accounting device ID input from the server device 4. The salesclerk S confirms the displayed specific information and conveys the specific information to the customer CU. The registration device 2 may display the specific information on a customer display unit, and in this case, the salesclerk S does not need to convey the displayed information to the customer CU. Then, the customer CU moves to the accounting device 3 indicated by the specific information, which is conveyed from the salesclerk S or displayed on the customer display unit, to pay the purchase price.

Next, each device of the accounting system 1 will be described in detail. First, the registration device 2 will be described. FIG. 3 is a block diagram illustrating a main hardware configuration of the registration device 2.

The registration device 2 includes a control unit 20, a memory unit 21, a display unit 22, an operation unit 23, a scanner 24, and a communication unit 25. The control unit 20, the memory unit 21, the display unit 22, the operation unit 23, the scanner 24, and the communication unit 25 are communicably connected to one another via a bus 26 or the like.

The control unit 20 is implemented by a computer including a central processing unit (CPU) 201, a read only memory (ROM) 202, and a random access memory (RAM) 203. The CPU 201, the ROM 202, and the RAM 203 are connected to one another via the bus 26.

The CPU 201 controls an overall operation of the registration device 2. The ROM 202 stores various programs such as a program used for driving the CPU 201, and various types of data. The RAM 203 is used as a work area of the CPU 201, and loads various programs and various types of data stored in the ROM 202 and the memory unit 21. The control unit 20 executes various types of control processing of the registration device 2 by the CPU 201 operating in accordance with a control program that is stored in the ROM 202 or the memory unit 21 and is loaded into the RAM 203.

The RAM 203 includes a commodity information unit 2031 and a member ID unit 2032. The commodity information unit 2031 is an area that stores commodity information (a commodity code, a commodity name, a price, and the like) of a commodity to be identified by a commodity code read by the scanner 24. The commodity information and the like are registered (stored) in the commodity information unit 2031, whereby the commodity registration is executed. The member ID unit 2032 is an area that stores the member ID read from a member card by the scanner 24 or input to the operation unit 23.

The memory unit 21 is implemented by a storage medium such as a hard disk drive (HDD) or a flash memory, and maintains stored content even when the power supply is cut off. The memory unit 21 stores a control program 211 and a commodity master 212.

The control program 211 is a program or the like for executing a function of executing commodity registration based on the commodity code read by the scanner 24, a function of transmitting the member ID registered in the member ID unit 2032 to the server device 4, a function of transmitting the commodity information registered in the commodity information unit 2031 to the accounting device 3 as accounting information, and the like.

The commodity master 212 is a master file in which a commodity code for identifying a commodity handled in a store and commodity information thereof (a commodity name, a price, and the like) are stored in association with each other. The commodity master 212 is distributed from the server device 4 and stored in the memory unit 21. Since commodities handled in the store change day by day, the commodity master 212 is appropriately updated. The commodity code is an example of commodity identification information for identifying a commodity.

The display unit 22 is implemented by, for example, a liquid crystal panel, and includes an operator display unit provided for the salesclerk S and a customer display unit provided for the customer CU. The display unit 22 displays various types of information. For example, the operator display unit and the customer display unit display commodity information of a registered commodity. The operator display unit and the customer display unit display specific information such as the accounting device ID input from the server device 4. The operator display unit can also display a commodity registration screen for inputting a commodity code of a commodity to which a code symbol is not attached.

The operation unit 23 is used for inputting information to the control unit 20, and is implemented by a keyboard, a touch panel that is provided on a surface of the display unit 22, or the like. For example, the salesclerk S operates the operation unit 23 to input a commodity code of a commodity, to which a code symbol is not attached, to the control unit 20. In addition, the salesclerk S operates the operation unit 23 to input accounting instruction information that declares completion of the commodity registration for one transaction to the control unit 20.

The scanner 24 reads a commodity code of a commodity based on a code symbol such as a barcode or a two-dimensional code attached to the commodity. The scanner 24 may be a radio frequency identification (RFID) reader that reads a commodity code from a wireless tag attached to the commodity. The scanner 24 reads a member code indicated on a member card or the like of the customer CU. The scanner 24 inputs the read information to the control unit 20.

The communication unit 25 is an interface for communicating with external devices such as the accounting device 3 and the server device 4. The control unit 20 can transmit and receive information (data) to and from an external device by being connected to the external device via the communication unit 25.

Next, a functional configuration of the control unit 20 of the registration device 2 will be described. FIG. 4 is a block diagram illustrating a main functional configuration of the control unit 20 of the registration device 2. The control unit 20 functions as an input unit 2001, a registration unit 2002, a transmission unit 2003, and a display processing unit 2004 by the CPU 201 operating in accordance with a control program stored in the ROM 202 or the memory unit 21. These functions may be implemented using hardware such as a dedicated circuit.

Various types of information are input to the input unit 2001 from the server device 4, the operation unit 23, and the scanner 24. For example, transaction start information that declares a start of one transaction and the accounting instruction information that declares the completion of the commodity registration for one transaction are input to the input unit 2001 from the operation unit 23. A commodity code and a member ID read by the scanner 24 are input from the scanner 24 to the input unit 2001. Further, an accounting device ID that specifies the accounting device 3 selected by the server device 4 is input from the server device 4 to the input unit 2001.

The registration unit 2002 registers commodity information of a commodity to be purchased by a customer. Specifically, the registration unit 2002 reads, from the commodity master 212, commodity information corresponding to a commodity code input to the input unit 2001 and registers the commodity information in the commodity information unit 2031, thereby executing the commodity registration. The registration unit 2002 may transmit, to the server device 4, an inquiry about the commodity information corresponding to the commodity code input to the input unit 2001 and acquire the commodity information from the server device 4. In this case, the registration device 2 may not store the commodity master 212. The registration unit 2002 registers a member ID input to the input unit 2001 in the member ID unit 2032.

The transmission unit 2003 transmits the commodity information registered by the registration unit 2002 to the accounting device 3 specified by specific information input from the server device 4. Specifically, the transmission unit 2003 transmits accounting information including the commodity information registered in the commodity information unit 2031, to the accounting device 3 specified by the accounting device ID that is input to the input unit 2001 from the server device 4. The transmission unit 2003 transmits the member ID registered in the member ID unit 2032 to the server device 4.

The display processing unit 2004 displays the specific information input from the server device 4 on the display unit 22. Specifically, the display processing unit 2004 displays the specific information such as the accounting device ID input from the server device 4 on the display unit 22. In addition, the display processing unit 2004 displays various types of information on the display unit 22. For example, the display processing unit 2004 displays the commodity information or the like registered by the registration unit 2002 on the display unit 22.

Next, the accounting device 3 will be described in detail. FIG. 5 is a block diagram illustrating a main hardware configuration of the accounting device 3.

The accounting device 3 includes a control unit 30, a memory unit 31, a display unit 32, an operation unit 33, a card reader 34, a change machine 35, and a communication unit 36. The control unit 30, the memory unit 31, the display unit 32, the operation unit 33, the card reader 34, the change machine 35, and the communication unit 36 are communicably connected to one another via a bus 37 or the like.

The control unit 30 is implemented by a computer including a CPU 301, a ROM 302, and a RAM 303. The CPU 301, the ROM 302, and the RAM 303 are connected to one another via the bus 37.

The CPU 301 controls an overall operation of the accounting device 3. The ROM 302 stores various programs such as a program used for driving the CPU 301 and various types of data. The RAM 303 is used as a work area of the CPU 301, and loads various programs and various types of data stored in the ROM 302 and the memory unit 31. The control unit 30 executes various types of control processing of the accounting device 3 by the CPU 301 operating in accordance with a control program that is stored in the ROM 302 or the memory unit 31 and is loaded into the RAM 303.

The memory unit 31 is implemented by a storage medium such as an HDD or a flash memory, and maintains stored content even when the power supply is cut off. The memory unit 31 stores a control program 311.

The control program 311 is a program for implementing a function of executing the accounting processing based on accounting information input from the registration device 2.

The display unit 32 is implemented by, for example, a liquid crystal panel, and displays various types of information. For example, the display unit 32 displays the accounting information input from the registration device 2. In addition, the display unit 32 displays guidance for guiding the customer CU to operate the accounting device 3, a selection screen for selecting a payment method of the purchase price, and the like.

The operation unit 33 is used for inputting information to the control unit 30, and is implemented by a touch panel provided on a surface of the display unit 32 or the like. The customer CU operates the operation unit 33 to input various types of information to the control unit 30. For example, with the operation unit 33, information indicating the payment method of the purchase price is input to the control unit 30.

The card reader 34 reads credit information necessary for credit card settlement from a credit card of the customer CU. The card reader 34 may be a magnetic card reader that reads information from a magnetic card, or may be an IC card reader that reads information from a card provided with a built-in IC chip.

When the customer CU pays the purchase price in cash, the change machine 35 receives banknotes and coins paid by the customer CU and dispenses change as necessary.

The communication unit 36 is an interface for communicating with external devices such as the registration device 2 and the server device 4. The control unit 30 can transmit and receive information (data) to and from an external device by being connected to the external device via the communication unit 36.

Next, a functional configuration of the control unit 30 of the accounting device 3 will be described. FIG. 6 is a block diagram illustrating a main functional configuration of the control unit 30 of the accounting device 3. The control unit 30 functions as an input unit 3001, an accounting processing unit 3002, and an output unit 3003 by the CPU 301 operating in accordance with a control program stored in the ROM 302 or the memory unit 31. These functions may be implemented using hardware such as a dedicated circuit.

Various types of information are input to the input unit 3001 from the registration device 2, the operation unit 33, and the card reader 34. For example, information indicating a payment method of the purchase price is input to the input unit 3001 from the operation unit 33. Credit information read by the card reader 34 is input to the input unit 3001 from the card reader 34. Further, accounting information is input to the input unit 3001 from the registration device 2.

The accounting processing unit 3002 executes accounting processing based on the accounting information input to the input unit 3001.

When the accounting processing executed by the accounting processing unit 3002 is completed, that is, when the payment of the purchase price by the customer CU is completed, the output unit 3003 outputs settlement completion information to the server device 4. The settlement completion information includes an accounting device ID for identifying the accounting device itself.

Next, the server device 4 will be described. FIG. 7 is a block diagram illustrating a main hardware configuration of the server device 4.

The server device 4 includes a control unit 40, a memory unit 41, a display unit 42, an operation unit 43, and a communication unit 44. The control unit 40, the memory unit 41, the display unit 42, the operation unit 43, and the communication unit 44 are connected to one another via a bus 45 or the like. The server device 4 may be implemented by a plurality of computers, and may include an external memory.

The control unit 40 is implemented by a computer including a CPU 401, a ROM 402, and a RAM 403. The CPU 401, the ROM 402, and the RAM 403 are connected to one another via the bus 45.

The CPU 401 controls an overall operation of the server device 4. The ROM 402 stores various programs such as a program used for driving the CPU 401 and various types of data. The RAM 403 is used as a work area of the CPU 401, and loads various programs and various types of data stored in the ROM 402 and the memory unit 41. The control unit 40 executes various types of control processing of the server device 4 by the CPU 401 operating in accordance with a control program that is stored in the ROM 402 or the memory unit 41 and is loaded into the RAM 403.

The memory unit 41 is implemented by a storage medium such as an HDD or a flash memory, and maintains stored content even when the power supply is cut off. The memory unit 41 stores a control program 411, a commodity master 412, a member master 413, an accounting device management file 414, and a priority setting file 415.

The control program 411 is a program or the like for implementing a function of acquiring a member ID from the registration device 2, a function of managing use statuses of the accounting device A to the accounting device G, a function of selecting an accounting device 3 for the customer CU to make a payment, and the like.

The commodity master 412 is a master file in which information on a commodity handled in a store is stored. Since the commodity handled in the store changes day by day, the commodity master 412 is appropriately updated. The updated commodity master 412 is distributed to the registration device 2.

The member master 413 is a file for managing information on the customer CU. The information on the customer CU stored in the member master 413 is registered when executing member registration for the customer CU to be a member of the store. FIG. 8 is a diagram illustrating a data configuration of the member master 413. Each piece of data registered in the member master 413 is associated with each piece of information indicating a member ID, a name, and request information.

In an item of member ID, a member ID that specifies a member is registered. The member ID can be said to be customer specific information that specifies the customer CU. In an item of name, information indicating a name is registered. In an item of request information, a request information number indicating a requested condition of the customer CU related to the accounting device 3 to be used is registered.

For example, when a member is a customer who visits a store with a bicycle on a daily basis and the member requests an accounting device 3 close to the exit X located on a bicycle parking lot side, “1” is registered in the item of request information. When the member is a customer who visits the store with an automobile on a daily basis and the member requests an accounting device 3 close to the exit Y located on a parking lot side, “2” is registered in the item of request information. When the member does not particularly request an accounting device 3 to be used, “3” is registered in the item of request information. When the member requests a specific accounting device 3, “4” is registered in the item of request information. In this case, an accounting device ID of the requested accounting device 3 is also registered.

The accounting device management file 414 is a file for managing the use statuses of the accounting device A to the accounting device G. The accounting device management file 414 is updated when the accounting device 3 for the customer CU to make a payment is selected by the server device 4 and when settlement completion information is input from each accounting device 3. FIG. 9 illustrates a data configuration of the accounting device management file 414. Each piece of data registered in the accounting device management file 414 is associated with each piece of information indicating an accounting device ID and a status.

In an item of accounting device ID, an accounting device ID that specifies the accounting device 3 is registered. “A” to “G” registered in the item of accounting device ID correspond to the accounting device A to the accounting device G illustrated in FIG. 2, respectively.

In an item of status, status information indicating a use status of the accounting device 3 is registered. The status information registered in the item of status is information indicating “in use” or “available”.

The priority setting file 415 is a file in which a priority of the accounting devices 3 is set according to the request information. FIG. 10 is a diagram illustrating a data configuration of the priority setting file 415. Each piece of data registered in the priority setting file 415 is associated with each piece of information indicating the request information, content, and a priority.

In an item of request information, a request information number indicating a requested condition of the customer CU related to the accounting device 3 to be used is registered. In an item of content, information indicating content of the request information is registered.

In an item of priority, information indicating a priority in selecting the accounting devices 3 by the server device 4 is registered. Priorities corresponding to the request information of “1” are set in an ascending order of distances to the exit X, that is, the accounting device A has the highest priority, the accounting device B has the second highest priority, . . . , and the accounting device G has the lowest priority. Priorities corresponding to the request information of “2” are set in an ascending order of distances to the exit Y, that is, the accounting device G has the highest priority, the accounting device F has the second highest priority, . . . , and the accounting device A has the lowest priority.

In the item of priority corresponding to the request information of “3”, information indicating the priority is not registered. In the item of priority corresponding to the request information of “4”, information indicating an accounting device 3 designated by the customer CU is registered.

In other words, when the request information is “1” or “2”, the accounting device 3 to be selected includes all of the accounting devices A to G, and the priorities for selection are set. When the request information is “3”, the accounting device 3 to be selected includes all of the accounting devices A to G, and the priorities for selection are not set. When the request information is “4”, the accounting device 3 to be selected includes only one accounting device 3 set by the customer CU.

When a member ID is input from the registration device 2, the server device 4 refers to the member master 413, the accounting device management file 414, and the priority setting file 415 to select the accounting device 3 for the customer CU to make a payment that is specified by the member ID.

Referring back to FIG. 7, the hardware of the server device 4 will be described. The display unit 42 is implemented by, for example, a liquid crystal panel, and displays various types of information. For example, the display unit 42 displays a registration screen for registering commodity information in the commodity master 412.

The operation unit 43 is used for inputting information to the control unit 40, and is implemented by a keyboard, a touch panel provided on a surface of the display unit 42, or the like. For example, with the operation unit 43, the commodity information registered in the commodity master 412 is input to the control unit 40.

The communication unit 44 is an interface for communicating with external devices such as the registration device 2 and the accounting device 3. The control unit 40 can transmit and receive information (data) to and from an external device by being connected to the external device via the communication unit 44.

Next, a main functional configuration of the control unit 40 of the server device 4 will be described. FIG. 11 is a block diagram illustrating the main functional configuration of the control unit 40 of the server device 4. The control unit 40 functions as an input unit 4001, an acquisition unit 4002, a management unit 4003, a selection unit 4004, and an output unit 4005 by the CPU 401 operating in accordance with a control program stored in the ROM 402 or the memory unit 41. These functions may be implemented using hardware such as a dedicated circuit.

Various types of information are input to the input unit 4001 from the registration device 2, the accounting device 3, and the operation unit 43. For example, the commodity information registered in the commodity master 412 is input from the operation unit 43 to the input unit 4001. In addition, a member ID of a customer CU who purchases a commodity is input from the registration device 2 to the input unit 4001. Further, settlement completion information is input from the accounting device 3 to the input unit 4001.

The acquisition unit 4002 acquires request information indicating a request of the customer CU related to selection of the accounting devices 3. Specifically, the acquisition unit 4002 reads, from the member master 413, a request information number corresponding to the member ID input to the input unit 4001. The acquisition unit 4002 may acquire the request information from the registration device 2. For example, the acquisition unit 4002 may acquire request information input by the salesclerk S or the customer CU when the commodity registration is executed by the registration device 2. In this case, the registration device 2 displays, on the display unit 22, a request information input screen that shows request information numbers and content corresponding to the request information numbers.

The management unit 4003 manages use statuses of the plurality of accounting devices 3. The management unit 4003 manages the use statuses of the accounting device A to the accounting device G by appropriately updating the accounting device management file 414. Specifically, when an accounting device 3 is selected by the selection unit 4004, the management unit 4003 registers “in use” in the item of status corresponding to an accounting device ID that specifies the selected accounting device 3. When the settlement completion information is input to the input unit 4001 from the accounting device 3, the management unit 4003 registers “available” in the item of status corresponding to the accounting device ID that specifies the accounting device 3.

The selection unit 4004 selects an accounting device 3 as an output destination of commodity information output by the registration device 2, based on the use statuses managed by the management unit 4003 and the request information acquired by the acquisition unit 4002. Specifically, the selection unit 4004 reads, from the accounting device management file 414, an accounting device ID of which status information is “available”. Then, the selection unit 4004 refers to the priority setting file 415 to read a priority corresponding to the request information number read from the member master 413 by the acquisition unit 4002. The selection unit 4004 selects an accounting device ID, which is read from the priority setting file 415 and has a higher priority, from among accounting device IDs read from the accounting device management file 414. Accordingly, the selection unit 4004 can select an accounting device 3 satisfying the request of the customer CU from among available accounting devices 3.

The output unit 4005 outputs, to the registration device 2, specific information that specifies the accounting device 3 selected by the selection unit 4004. Specifically, the output unit 4005 outputs, to the registration device 2, the accounting device ID of the accounting device 3 selected by the selection unit 4004.

Next, operations of the accounting system 1 having the above-mentioned configuration will be described. FIG. 12 is a sequence chart illustrating a flow of the operations of the accounting system 1.

Before executing commodity registration by the registration device 2, a member ID of a customer CU is input to the registration device 2 (ACT 1). When a commodity code of a purchased commodity is read by the scanner 24 and the commodity code is input, the registration device 2 executes the commodity registration (ACT 2). The registration device 2 executes commodity registration for all commodities purchased by the customer CU.

When the commodity registration is completed for all the commodities purchased by the customer CU, accounting instruction information is input to the registration device 2 by an operation of the salesclerk S (ACT 3). The registration device 2 transmits the member ID input in ACT 1 to the server device 4 (ACT 4).

When the server device 4 receives the member ID, the server device 4 executes accounting device selection processing of selecting an accounting device 3 for the customer CU to make a payment that is specified by the member ID (ACT 5). Details of the accounting device selection processing executed by the server device 4 will be described later.

The server device 4 updates the accounting device management file 414 based on a result of the accounting device selection processing (ACT 6). More specifically, the server device 4 rewrites the status information of the selected accounting device 3 to “in use”. The server device 4 outputs an accounting device ID that specifies the selected accounting device 3 to the registration device 2 (ACT 7).

The registration device 2 displays the accounting device ID on the display unit 22 (ACT 8). The salesclerk S operating the registration device 2 guides the customer CU to the accounting device 3 specified by the accounting device ID displayed on the display unit 22. The registration device 2 transmits accounting information to the accounting device 3 specified by the accounting device ID input in ACT 7 (ACT 9), and clears information registered in the commodity information unit 2031 (ACT 10). The registration device 2 may transmit the accounting information to the accounting device 3 via the server device 4.

The accounting device 3 to which the accounting information is input from the registration device 2 executes accounting processing (ACT 11). When the accounting processing is completed, that is, when payment of a purchase price by the customer CU is completed, the accounting device 3 outputs settlement completion information to the server device 4 (ACT 12). The settlement completion information includes the accounting information and the accounting device ID.

The server device 4 updates the accounting device management file 414 based on the settlement completion information input from the accounting device 3 (ACT 13). More specifically, the server device 4 rewrites the status information corresponding to the accounting device ID included in the settlement completion information to “available”. Through the above-mentioned operations, payment of the purchase price by the customer CU is completed.

Next, the accounting device selection processing executed by the server device 4 will be described. FIG. 13 is a flowchart illustrating a flow of the accounting device selection processing executed by the control unit 40 of the server device 4.

The control unit 40 determines whether a member ID is input to the input unit 4001 (ACT 21), and when no member ID is input (No in ACT 21), the control unit 40 returns to the processing of ACT 21 and stands by. When a member ID is input to the input unit 4001 (Yes in ACT 21), the selection unit 4004 reads request information corresponding to the input member ID from the member master 413 (ACT 22).

Next, the selection unit 4004 extracts, from the priority setting file 415, a priority corresponding to the request information read in ACT 22, and selects an accounting device 3 to be selected as an output destination of accounting information. Then, priorities are set for accounting devices 3 to be selected (ACT 23).

The selection unit 4004 refers to the accounting device management file 414 to determine whether there is an available accounting device 3 among the accounting devices 3 to be selected (ACT 24). When there is an available accounting device 3 (Yes in ACT 24), the selection unit 4004 selects any of available accounting devices 3 based on the priorities set in ACT 23 (ACT 25).

For example, as illustrated in FIG. 2, in a situation in which the accounting device A, the accounting device D, and the accounting device G are in use, when the request information of the customer CU who is to make a payment is “1”, the selection unit 4004 selects the accounting device B. More specifically, the selection unit 4004 selects the accounting device B having the highest priority among the available accounting devices 3. Accordingly, the selection unit 4004 can make a selection satisfying a request of the customer CU who requests an accounting device 3 close to the exit X. When the request information of the customer CU who is to make a payment is “3”, the selection unit 4004 selects any accounting device 3 from among the available accounting devices 3.

Next, the output unit 4005 outputs an accounting device ID that specifies the accounting device 3 selected by the selection unit 4004 to the registration device 2 from which the member ID is input to the input unit 4001 (ACT 26). Then, the control unit 40 ends the accounting device selection processing.

In the processing of ACT 24, when there is no available accounting device 3 (No in ACT 24), the output unit 4005 outputs, to the registration device 2 from which the member ID is input to the input unit 4001, information indicating that there is no available requested accounting device 3 (ACT 27). Then, the control unit 40 returns to the processing of ACT 24. Through the above-mentioned accounting device selection processing, the server device 4 can select the accounting device 3 satisfying the request of the customer CU.

As described above, the information processing apparatus (the server device 4) according to the first embodiment is an information processing apparatus (a server device 4) used in the accounting system 1. The accounting system 1 includes: the registration device 2 configured to register, by an operation of a salesclerk, commodity information of a commodity purchased by a customer; and the plurality of accounting devices 3 configured to execute accounting processing by an operation of the customer based on the commodity information registered by the registration device 2. The information processing apparatus includes: the management unit 4003 configured to manage use statuses of the plurality of accounting devices 3; the acquisition unit 4002 configured to acquire request information indicating a request of the customer related to selection of the accounting devices 3; and the selection unit 4004 configured to select the accounting device 3 as an output destination of the commodity information output by the registration device 2, based on the use statuses managed by the management unit 4003 and the request information acquired by the acquisition unit 4002.

Accordingly, the customer CU can pay a purchase price by the accounting device 3 satisfying the request of the customer CU. Therefore, the accounting system 1 and the server device 4 according to the first embodiment can improve the service for the customer.

### Second Embodiment

Next, a second embodiment will be described. In the second embodiment, an accounting system 6 is a cart POS system, and the accounting system 6 notifies a customer of an accounting device 3 satisfying his/her request when the customer CU completes registration of all commodities. Hereinafter, descriptions of configurations and functions similar to those of the first embodiment may be omitted. This is to avoid unnecessary redundancy of the following descriptions and to facilitate understanding of a person skilled in the art.

FIG. 14 is a diagram illustrating a configuration of the accounting system 6. The accounting system 6 includes a plurality of accounting devices 3, the server device 4, and terminal devices 7 respectively provided in a plurality of shopping carts SC. Each terminal device 7 is communicably connected to the accounting devices 3 and the server device 4 via a wireless LAN.

The terminal device 7 includes a customer terminal such as a smartphone owned by a customer CU, a store terminal such as a tablet terminal owned by a store, and the like, and a shopping application program is installed in the terminal device 7. The terminal device 7 can execute commodity registration by capturing an image of a code symbol such as a barcode attached to a commodity with a scanner, and can function as a registration device.

The customer CU performs the commodity registration in the salesroom by using the terminal device 7. The terminal device 7 is an example of a registration device that moves together with the customer CU and that registers commodity information of a commodity by an operation of the customer CU. The terminal device 7 can transmit accounting information including the commodity information of the registered commodity to the accounting device 3.

Accordingly, the customer CU can pay a purchase price by the accounting device 3. In addition, the terminal device 7 includes a positioning unit capable of positioning a self position. The terminal device 7 can transmit position information indicating the positioned self position to the server device 4.

FIG. 15 is a diagram illustrating an accounting space of a store to which the accounting system 6 according to the present embodiment is applied. In the present embodiment, since the commodity registration is executed in the salesroom by the terminal devices 7 provided in the shopping carts SC, no registration device is disposed in the accounting space.

When the customer CU completes the commodity registration of all the purchased commodities, the customer CU inputs accounting instruction information to the terminal device 7. When the accounting instruction information is input to the terminal device 7, the terminal device 7 transmits, to the server device 4, a member ID that specifies the customer CU, the accounting information including the registered commodity information, and position information indicating a position of the terminal device 7. The server device 4 selects an accounting device 3 according to the received member ID and use statuses of the plurality of accounting devices 3 in the same manner as in the first embodiment.

At this time, in the present embodiment, the server device 4 selects one accounting device 3 based on request information registered in the member master 413, status information registered in the accounting device management file 414, and the position information received from the terminal device 7. The server device 4 selects, from among available accounting devices 3, an accounting device 3 having a high priority that is specified by the request information. When the priority is not specified by the request information, the server device 4 selects an accounting device 3 based on the position information.

For example, when the request information registered in the member master 413 is “3”, that is, when all the accounting devices 3 are to be selected and no priority is specified, the server device 4 selects an accounting device 3 based on the position information acquired from the terminal device 7. Specifically, the server device 4 selects the accounting device 3 located closest to the terminal device 7. A method of selecting an accounting device 3 based on the request information, the status information, and the position information is not limited to the above-mentioned method, and a different selection method may be adopted.

The server device 4 issues a transaction ID with respect to the input accounting information. The server device 4 outputs an accounting device ID, which specifies the selected accounting device 3, and the issued transaction ID to the terminal device 7.

The terminal device 7 displays, on a display unit, a transaction code created based on the transaction ID input from the server device 4, and the accounting device ID. The displayed accounting device ID indicates an accounting device 3 satisfying the request of the customer CU when the customer CU completes the commodity registration. That is, the server device 4 notifies the customer CU of an accounting device 3 recommended when the commodity registration by the customer CU is completed.

The customer CU moves to the accounting device 3 displayed on the terminal device 7, and causes the accounting device 3 to read the displayed transaction code. The accounting device 3 acquires accounting information corresponding to the read transaction code from the server device 4 and executes accounting processing. Thus, the customer CU can pay the purchase price. If the accounting device 3 is being used when the customer CU moves to the accounting device 3 displayed on the terminal device 7, the customer CU can make a payment with another available accounting device 3.

Next, each device of the accounting system 6 will be described in detail. First, the terminal device 7 will be described. A description of a configuration similar to that of the registration device 2 according to the first embodiment may be omitted. FIG. 16 is a block diagram illustrating a main hardware configuration of the terminal device 7.

The terminal device 7 includes a control unit 70, a memory unit 71, a display unit 72, an operation unit 73, a scanner 74, a positioning unit 75, and a communication unit 76. The control unit 70, the memory unit 71, the display unit 72, the operation unit 73, the scanner 74, the positioning unit 75, and the communication unit 76 are communicably connected to one another via a bus 77 or the like.

The positioning unit 75 measures a position where the terminal device 7 is present. The positioning unit 75 is, for example, a global positioning system (GPS), or a position measurement device using a beacon positioning technique.

Next, a functional configuration of the control unit 70 of the terminal device 7 will be described. FIG. 17 is a block diagram illustrating a main functional configuration of the control unit 70 of the terminal device 7. The control unit 70 functions as an input unit 7001, a registration unit 7002, a transmission unit 7003, and a display processing unit 7004 by the CPU 701 operating in accordance with a control program stored in the ROM 702 or the memory unit 71. These functions may be implemented using hardware such as a dedicated circuit.

The position information is input from the positioning unit 75 to the input unit 7001 in addition to the information input to the input unit 2001 of the registration device 2 in the first embodiment. The position information input to the input unit 7001 is information indicating the position of the terminal device 7. The transaction ID is input from the server device 4 to the input unit 7001 together with the accounting device ID.

The registration unit 7002 has the same function as that of the registration unit 2002 of the registration device 2 in the first embodiment.

The transmission unit 7003 has the following function in addition to a function of the transmission unit 2003 of the registration device 2 in the first embodiment. When the accounting instruction information is input from the operation unit 73 to the input unit 7001, the transmission unit 7003 transmits, to the server device 4, the position information input from the positioning unit 75 to the input unit 7001. In other words, when the commodity registration of all the purchased commodities is completed and the customer CU issues an accounting instruction, the transmission unit 7003 transmits the position information indicating the position of the terminal device 7 to the server device 4. At this time, the transmission unit 7003 also transmits the member ID and the accounting information.

The display processing unit 7004 has the following function in addition to a function of the display processing unit 2004 of the registration device 2 in the first embodiment. The display processing unit 7004 causes the display unit 72 to display a transaction code obtained by encoding the transaction ID input from the server device 4 to the input unit 7001. The transaction code is displayed as a barcode or a two-dimensional code.

Next, the accounting device 3 will be described in detail. FIG. 18 is a block diagram illustrating a main hardware configuration of the accounting device 3.

The accounting device 3 includes a scanner 38 in addition to those of the accounting device 3 according to the first embodiment. The scanner 38 reads a transaction ID from the transaction code displayed by the terminal device 7. The scanner 38 may read a commodity code from a code symbol attached to a commodity and acquire commodity information thereof from the server device 4. Accordingly, the accounting device 3 can also be used as a self-checkout POS terminal device.

Next, a functional configuration of the control unit 30 of the accounting device 3 will be described. FIG. 19 is a block diagram illustrating a main functional configuration of the control unit 30 of the accounting device 3. The control unit 30 functions as the input unit 3001, the accounting processing unit 3002, and the output unit 3003, similarly to the control unit 30 of the accounting device 3 in the first embodiment.

In addition to the various types of information input to the input unit 3001 in the first embodiment, the transaction ID is input from the scanner 38 to the input unit 3001. The transaction ID is read by the scanner 38 from the transaction code displayed by the terminal device 7.

A function of the accounting processing unit 3002 is the same as that in the first embodiment.

In addition to the function of the output unit 3003 in the first embodiment, the output unit 3003 outputs, to the server device 4, the transaction ID input to the input unit 3001 and the accounting device ID that specifies the own accounting device.

Next, the server device 4 will be described. FIG. 20 is a block diagram illustrating a main hardware configuration of the server device 4.

The server device 4 includes the following configuration in addition to the configuration of the server device 4 according to the first embodiment. The RAM 403 includes a transaction information unit 4031. The transaction information unit 4031 stores transaction information in which the accounting information received from the terminal device 7 and the transaction ID issued by the control unit 40 are associated with each other. FIG. 21 is a diagram illustrating a data configuration of the transaction information unit 4031. Each piece of data registered in the transaction information unit 4031 is associated with each piece of information indicating the transaction ID and the accounting information.

In an item of transaction ID, a transaction ID issued correspondingly to the accounting information received from the terminal device 7 is registered. In an item of accounting information, accounting information received from the terminal device 7 is registered.

The memory unit 41 stores a map information file 416. The map information file 416 is a file in which map information indicating a sketch in a store that includes a salesroom and an accounting space is stored. The server device 4 can refer to the map information file 416, and determine a distance between the terminal device 7 and each accounting device 3 based on the position information acquired from the terminal device 7.

Next, a main functional configuration of the control unit 40 of the server device 4 will be described. FIG. 22 is a block diagram illustrating a main functional configuration of the control unit 40 of the server device 4. The control unit 40 functions as the input unit 4001, the acquisition unit 4002, the management unit 4003, the selection unit 4004, and the output unit 4005, similarly to the control unit 40 of the server device 4 in the first embodiment. In addition to these units, the control unit 40 also functions as a position information acquisition unit 4006.

The accounting information and the position information are input from the terminal device 7 to the input unit 4001 in addition to the member ID.

A function of the acquisition unit 4002 is the same as that in the first embodiment.

The management unit 4003 is different from that in the first embodiment in a timing of registering “in use” in the accounting device management file 414. In the first embodiment, when the accounting device 3 is selected by the selection unit 4004, “in use” is registered in the item of status corresponding to the accounting device ID that specifies the selected accounting device 3. In contrast, in the present embodiment, when the transaction ID and the accounting device ID are received from the accounting device 3 that reads the transaction code, “in use” is registered in association with the accounting device ID. This is because, in the present embodiment, the customer CU does not always pay the purchase price at the accounting device 3 selected by the server device 4.

In the same manner as in the first embodiment, the selection unit 4004 selects the accounting device 3 based on the use statuses managed by the management unit 4003 and the request information acquired by the acquisition unit 4002. However, when the request information of the customer CU is “3”, that is, when the customer CU does not request an accounting device 3, the selection unit 4004 selects an accounting device 3 based on the position information acquired by the position information acquisition unit 4006. Specifically, when the request information of the customer CU is “3”, the selection unit 4004 selects an accounting device 3 closest to the terminal device 7 operated by the customer CU.

The output unit 4005 outputs the accounting information to the accounting device 3 that inputs the accounting device ID and the transaction ID to the input unit 4001. The output unit 4005 refers to the transaction information unit 4031, and outputs the accounting information corresponding to the transaction ID input from the accounting device 3. In other words, the output unit 4005 outputs the accounting information corresponding to the transaction code to the accounting device 3 that the customer CU uses to read the transaction code.

The position information acquisition unit 4006 acquires position information indicating a position where the terminal device 7 is present. Specifically, the position information acquisition unit 4006 acquires the position information input from the terminal device 7 to the input unit 4001.

Next, operations of the accounting system 6 having the above-mentioned configuration will be described. FIG. 23 is a sequence chart illustrating a flow of the operations of the accounting system 6. The same processing as that in the first embodiment is denoted by the same reference sign, and a detailed description thereof may be omitted.

The processing of ACT 1 to ACT 3 is the same as that in the first embodiment. When the accounting instruction is input to the terminal device 7 by the operation of the customer CU, the terminal device 7 transmits, to the server device 4, the member ID input in ACT 1, the accounting information including the commodity information registered in the commodity information unit 7031, and the position information input to the input unit 7001 (ACT 31).

The server device 4 issues a transaction ID corresponding to the accounting information input from the terminal device 7, associates the accounting information with the transaction ID, and registers the associated accounting information and transaction ID in the transaction information unit 4031 (ACT 32). Then, the server device 4 executes accounting device selection processing (ACT 33). Details of the accounting device selection processing in the present embodiment will be described later. The server device 4 outputs, to the terminal device 7, the issued transaction ID, and the accounting device ID that specifies the accounting device 3 selected in the accounting device selection processing (ACT 34).

The terminal device 7 displays, on the display unit 72, information including both the specific information such as the accounting device ID input from the server device 4 and the transaction code obtained by two-dimensionally encoding the transaction ID (ACT 35). FIG. 24 illustrates a display screen displayed on the display unit 72. A display screen 721 is partitioned to form a message display portion 7211 and a code display portion 7212.

The message display portion 7211 displays a message notifying the customer CU of the accounting device 3 recommended to the customer CU. For example, the message display portion 7211 displays a message such as “accounting device A is recommended at the present time” is displayed. The customer CU sees the message displayed in the message display portion 7211 and then moves to the accounting device A. Each accounting device 3 preferably includes a display unit that allows the customer CU to confirm the specific information (the accounting device ID, an accounting device number, and the like) from a distant position. In addition, a two-dimensional code indicating the transaction ID is displayed in the code display portion 7212. The two-dimensional code may indicate the accounting information including the commodity information of the purchased commodity.

When the customer CU moves to the accounting device 3 and holds the transaction code displayed on the terminal device 7 over the scanner 38 of the accounting device 3, the accounting device 3 reads the transaction ID (ACT 36). The accounting device 3 outputs, to the server device 4, the read transaction ID and the accounting device ID that specifies the accounting device 3 (ACT 37).

The server device 4 updates the accounting device management file 414 based on the accounting device ID input from the accounting device 3 (ACT 38). Then, the server device 4 outputs, to the accounting device 3, the accounting information corresponding to the transaction ID input from the accounting devices 3 (ACT 39). The subsequent processing is the same as that in the first embodiment.

Next, the accounting device selection processing according to the present embodiment executed by the server device 4 will be described. FIG. 25 is a flowchart illustrating a flow of the accounting device selection processing executed by the control unit 40 of the server device 4. The same processing as that of the accounting device selection processing according to the first embodiment is denoted by the same reference sign, and a detailed description thereof may be omitted.

The processing of ACT 21 and ACT 22 is the same as that of the accounting device selection processing according to the first embodiment. The selection unit 4004 determines whether the read request information is “3” (ACT 41). If the read request information is not “3” (No in ACT 41), the control unit 40 proceeds to the processing of ACT 23, and thereafter executes the same processing as in the accounting device selection processing according to the first embodiment.

If the read request information is “3” (Yes in ACT 41), the selection unit 4004 determines whether the position information is acquired by the position information acquisition unit 4006 (ACT 42). When the position information is acquired by the position information acquisition unit 4006(Yes in ACT 42), the control unit 40 proceeds to the processing of ACT 23, and the selection unit 4004 sets the priority of the accounting devices 3 based on the position information in ACT 23.

In the processing of ACT 42, if the position information is not acquired by the position information acquisition unit 4006 (No in ACT 42), the control unit 40 returns to the processing of ACT 42 and stands by. The subsequent processing is the same as that in the accounting device selection processing according to the first embodiment. Through the above-mentioned accounting device selection processing, the server device 4 can notify the customer CU of the accounting device 3 satisfying the request of the customer CU. In addition, when the customer CU does not request an accounting device 3 for payment, it is possible to notify the customer CU of an accounting device 3 close to a position where the customer CU executes the accounting instruction input.

As described above, the information processing apparatus (the server device 4) according to the second embodiment is an information processing apparatus used in the accounting system 6. The accounting system 6 includes: a registration device (the terminal device 7) configured to move together with a customer CU and that registers commodity information of a commodity by an operation of the customer CU; and the plurality of accounting devices 3 configured to execute accounting processing by an operation of the customer CU based on the commodity information registered by the registration device. The information processing apparatus includes: the management unit 4003 configured to manage use statuses of the plurality of accounting devices 3; the acquisition unit 4002 configured to acquire request information indicating a request of the customer CU related to the selection of the accounting device 3; and the selection unit 4004 configured to select the accounting device 3 to be recommended to the customer CU based on the use statuses managed by the management unit 4003 and the request information acquired by the acquisition unit 4002.

Accordingly, the server device 4 can notify the customer CU of the accounting device 3 satisfying the request of the customer CU. Therefore, the accounting system 6 and the server device 4 according to the second embodiment can improve the service for the customer CU.

The information processing apparatus (the server device 4) according to the second embodiment further includes the position information acquisition unit 4006 that acquires position information indicating a position of the registration device (the terminal device 7). The selection unit 4004 selects the accounting device 3 to be recommended to the customer CU, based on the use statuses managed by the management unit 4003, the request information acquired by the acquisition unit 4002, and the position information acquired by the position information acquisition unit 4006.

Accordingly, the server device 4 can notify the customer CU, who does not request an accounting device 3 to be used, of an accounting device 3 at a position close to the customer CU. Also in this regard, the accounting system 6 and the server device 4 according to the second embodiment can improve the service for the customer CU.

In the above-mentioned embodiments, the control program executed by each of the registration device 2, the accounting device 3, the server device 4, and the terminal device 7 may be provided by being recorded in a computer-readable recording medium such as a CD-ROM. The control program executed by each device of the above-mentioned embodiments may be provided by being stored in a computer connected to a network such as the Internet and then downloaded via the network, or may be provided via the network such as the Internet.

While certain embodiments have been described, these embodiments have been presented by way of example only, and are not intended to limit the scope of the disclosure. Indeed, the embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An information processing apparatus to be used in an accounting system, the accounting system comprising a registration device configured to register, by an operation of a salesclerk, commodity information of a commodity purchased by a customer, and a plurality of accounting devices each configured to execute accounting processing by an operation of the customer based on the commodity information registered by the registration device, the information processing apparatus comprising:
a management component configured to manage a use status of the plurality of accounting devices;
an acquisition component configured to acquire request information indicating a request of the customer related to selection of the accounting devices; and
a selection component configured to select the accounting device as an output destination of the commodity information output by the registration device, based on the use status managed by the management component and the request information acquired by the acquisition component.

2. The information processing apparatus according to claim 1, wherein the selection component selects the accounting device satisfying a request of the customer from among available accounting devices of the plurality of accounting devices.

3. The information processing apparatus according to claim 1, wherein
the registration device is one of a tablet terminal or a smartphone.

4. An accounting system, comprising:
a registration device configured to register, by an operation of a salesclerk, commodity information of a commodity purchased by a customer;
a plurality of accounting devices each configured to execute accounting processing by an operation of the customer based on the commodity information registered by the registration device; and
a server device communicably connected to the registration device and the plurality of accounting devices, wherein
the server device comprises:
a management component configured to manage a use status of the plurality of accounting devices;
an acquisition component configured to acquire request information indicating a request of the customer related to selection of the accounting devices;
a selection component configured to select the accounting device as an output destination of the commodity information output by the registration device, based on the use status managed by the management component and the request information received by the acquisition component; and
an output component configured to output, to the registration device, specific information that specifies the accounting device selected by the selection component, and
the registration device comprises:
a registration component configured to register the commodity information of the commodity purchased by the customer; and
a transmission component configured to transmit the commodity information registered by the registration component to the accounting device specified by the specific information input from the server device.

5. The accounting system according to claim 4, wherein
the registration device further comprises a display processing component configured to cause a display unit to display the specific information input from the server device.

6. The accounting system according to claim 4, wherein the selection component selects the accounting device satisfying a request of the customer from among available accounting devices of the plurality of accounting devices.

7. The accounting system according to claim 4, wherein
the registration device is one of a tablet terminal or a smartphone.

8. An information processing apparatus to be used in an accounting system, the accounting system comprising a registration device configured to move together with a customer and register commodity information of a commodity by an operation of the customer, and a plurality of accounting devices configured to execute accounting processing by an operation of the customer based on the commodity information registered by the registration device, the information processing apparatus comprising:
a management component configured to manage a use status of the plurality of accounting devices;
an acquisition component configured to acquire request information indicating a request of the customer related to selection of the accounting devices; and
a selection component configured to select the accounting device to be recommended to the customer, based on the use status managed by the management component and the request information acquired by the acquisition component.

9. The information processing apparatus according to claim 8, further comprising:
a position information acquisition component configured to acquire position information indicating a position of the registration device, wherein
the selection component selects the accounting device to be recommended to the customer, based on the use status managed by the management component, the request information acquired by the acquisition component, and the position information acquired by the position information acquisition component.

10. The information processing apparatus according to claim 8, wherein the selection component selects the accounting device satisfying a request of the customer from among available accounting devices of the plurality of accounting devices.

11. The information processing apparatus according to claim 8, wherein
the registration device is one of a tablet terminal or a smartphone.

12. An accounting system, comprising:
a registration device configured to move together with a customer and register commodity information of a commodity purchased by the customer;
a plurality of accounting devices each configured to execute accounting processing by an operation of the customer based on the commodity information registered by the registration device; and
a server device communicably connected to the registration device and the plurality of accounting devices, wherein
the server device comprises:
a management component configured to manage a use status of the plurality of accounting devices;
an acquisition component configured to acquire request information indicating a request of the customer related to selection of the accounting devices;
a selection component configured to select the accounting device to be recommended to the customer, based on the use status managed by the management component and the request information acquired by the acquisition component; and
an output component configured to output, to the registration device, specific information that specifies the accounting device selected by the selection component, and
the registration device comprises:
a display processing component configured to cause a display component to display the specific information input from the server device.

13. The accounting system according to claim 12, wherein the selection component selects the accounting device satisfying a request of the customer from among available accounting devices of the plurality of accounting devices.

14. The accounting system according to claim 12, wherein
the registration device is one of a tablet terminal or a smartphone.
